(19) United States
(12) Patent Application Publication
(10) Pub. No.: US 2007/0143162 A1
(43) Pub. Date: Jun. 21, 2007

(54) RFID with two tier connectivity, RFID in the PLC rack, secure RFID tags and RFID multiplexer system

(75) Inventors: John Keever, Boca Raton, FL (US); David De La Rosa, Boca Raton, FL (US); Eric Aupperlee, Deer Park, NY (US); Wendy Wussow, Boca Raton, FL (US); James Wert JR., Boca Raton, FL (US); Nils Bertelsen, Boynton Beach, FL (US)

Correspondence Address: Bryan H. Opalko, Esquire;Buchanan Ingersoll & Rooney PC, One Oxford Centre, 20th Floor, 301 Grant Street, Pittsburgh, PA, 15219, US

(73) Assignee: ILS Technology LLC, Boca Raton, FL (US)

(21) Appl. No.: 11/599,771

(22) Filed: Nov. 15, 2006

Related U.S. Application Data
(60) Provisional application No. 60/736,908, filed on Nov. 15, 2005.

(51) Int. Cl. G06F 9/44

(52) U.S. Cl. 705/7; 340/10.1; 235/376; 717/176

(57) ABSTRACT

A device by which RFID data can pass from the RFID reader, or from the plant floor PLC and reader, to business applications at the enterprise level. The RFID tag date is easily integrated into a PLC for integration with other equipment. The security of the overall system is maintained by only allowing tag information to be available to authenticated users by means of active or passive tags and the use of certificates and encryption during the data transmission. Multiple RFID reader device drivers can be customized to support any number of readers available in the marketplace, with each RFID reader including its own data structure, protocol and handshaking methodology for communication. Additionally, a set of run time and configuration tools is provided which allow for an easier integration of RFID tag data into the enterprise architecture for use by other business applications.

### CROSS REFERENCE TO RELATED APPLICATIONS

This application claims the benefit of co-pending provisional patent application Ser. No. 60/736,908 entitled “RFID in the PLC Rack or RFID with 2 Tier Connectivity Also Secure RFID Tags and RFID Multiplexer”, filed on Nov. 15, 2005, the entire disclosure of which is incorporated by reference herein.

This application is related to U.S. patent application Ser. No. 11/142,200 entitled “Model for Communication Between Manufacturing and Enterprise Levels”, filed Jun. 1, 2005, the entire disclosure of which is incorporated by reference herein.

### FIELD OF THE INVENTION

The present invention is directed toward RFID readers and, more particularly, toward intelligent RFID readers capable of communicating directly with enterprise level applications and/or with manufacturing automation devices such as Programmable Logic Controllers.

### BACKGROUND OF THE INVENTION

There are several limitations in current RFID (Radio Frequency IDentification) systems technology, namely: (1) the ability to easily integrate the information with existing enterprise applications; (2) the ability to integrate the information to plant floor PLCs (Programmable Logic Controllers); (3) security of the information transmitted; and (4) the ability to use different reader technology with the infrastructure (for different locations or plants). There is also currently a reliance on upper level systems to perform any logic activity, meaning that the RFID reader and antennas must have connectivity to a local host to carry out their activities.

Current RFID systems have a combination of antennas, readers, integration software and application function. In some business applications, there is a requirement for a local software application to apply the appropriate business rule to the tag data locally. In these business environments, the current set of pieces required to build the final system works fine. However, in other business applications, there is no requirement for local manipulation of the tag data. Instead, the data just needs to be moved to the enterprise level for tracking and storage. In these business environments, the local integration and application software is cumbersome and expensive and does not provide any business value add beyond the general integration function. For these business environments, what is needed is a simple configuration system that will allow standard tag information to be propagated to the enterprise level without customer programming.

Typical installations currently require both custom programming and additional hardware tiers, as shown in FIG. 1. In FIG. 1, an RF tag would pass near an RF antenna 300, which would sense the presence of the RF tag. That data would be transmitted to the RFID reader 400, and then either sent to a local PC 700, or held for polling in the RFID reader 400 until the local PC 700 requested the information. The local PC 700 would then run some form of logic application to determine if the RF data is valid and if the RF data needed to be sent to a business application at the enterprise level. If the RFID tag information is to be passed to the business application/system, it is typically first forwarded to a data concentrator 1100 for queuing and integration to the business application 602 at the host 600.

In addition to integration with the enterprise level, some customers need RFID tag information available in the PLCs for use in plant floor operations. Current systems do not allow that information to pass easily into the PLC and require special systems and programming. Such special systems add complexity and expense. What is needed is a way to easily read the tag information and to configure where it gets stored in the PLC.

The communication between the current RFID tags and their readers is generally a request/response with handshaking. Any reader can sense a tag and, if within the standard range, can read the data on that tag. This means that RFID information intended to be used by one company has the possibility of being read and used by any outside group without the original company's knowledge or consent. For example, readers at a company receiving packages from a local shipper could inadvertently read the local shipper's RFID tags on packages as they pass through a nearby hall or area in proximity to the readers. Depending on the information stored on the RF tag, this could be considered a security breach. Therefore, what is needed to improve RFID-security is an upgraded protocol which requires additional security before the RFID tag information is released. This would insure that only authorized personnel or systems would be allowed to access sensitive data on the RFID tag.

Many manufacturers provide RFID read/write systems which use different communication protocols. For large companies with many plant locations, they may have different brands and/or models of RFID readers employed through the company. When such a company attempts to integrate the RFID information with their enterprise level systems, they require different communication software for each reader brand and/or model. What is therefore needed is a system which can communicate with a variety of these reader protocols and provide a standard interface to the enterprise application level.

At the plant floor level, there are devices to provide feedback to the operators on whether or not a tag read happened correctly. Some systems employ light poles with red, yellow and green lights to indicate if the tag was read properly. Companies may require data checks on the tag information before the light color is changed. Current systems generally require specialized coding to make the logic checks that are required by each business. Therefore, what is needed is a simple tool that allows a plant floor engineer to create a set of simple rules and their order of execution that will allow these data checks and business functions to be defined in graphical manner without programming.

The present invention is directed toward overcoming one or more of the above-identified problems.

### SUMMARY OF THE INVENTION

The present invention provides a means by which RFID data can pass from the RFID reader, or from the plant floor PLC and reader, to business applications at the enterprise level. An efficient RFID system is provided whereby the RFID tag data can be easily integrated into a PLC for integration with other equipment. The security of the overall system is maintained by only allowing tag information to be available to authenticated users by means of active or passive tags and the use of certificates and encryption during the data transmission. Multiple RFID reader device drivers can be customized to support any number of readers available in the marketplace, with each RFID reader including its own data structure, protocol and handshaking methodology for communication. The present invention also includes a set of run time and configuration tools which allow for an easier integration of RFID tag data into the enterprise architecture for use by other business applications.

It is an object of the present invention to move RFID tag data from the RFID reader and/or a PLC to the enterprise level.

It is a further object of the present invention to read RFID tag information and place it into a PLC data tag registry.

It is still a further object of the present invention to provide a tool to both configure the RFID reader and to assign what pieces of information get placed in which PLC data tag variables.

It is yet a further object of the present invention to provide a tool to easily create data rules on what operations need to happen associated with an RFID tag read for control of status poles and other local devices.

It is an additional object of the present invention to provide context normalization of the multiple RFID tag/reader formats so applications are insulated from the reader format specific details to allow the use of any brand reader.

It is yet an additional object of the present invention to provide for security of data transmitted from RFID tags.

It is still an additional object of the present invention to act as a “multiplexer” to control multiple different types of readers from a single PLC.

Other objects, aspects and advantages of the present invention can be obtained from a study of the specification, the drawings, and the appended claims.

### BRIEF DESCRIPTION OF THE DRAWINGS

The foregoing and other features and advantages of the present invention will be apparent from the following, more particular description of a preferred embodiment of the invention, as illustrated in the accompanying drawings wherein like reference numbers generally indicate identical, functionally similar, and/or structurally similar elements.
FIG. 1 depicts a prior, typical implementation of communication from an RFID reader to enterprise level;

FIG. 2 depicts a two tier implementation of communication from an RFID reader to enterprise level according to a first embodiment of the present invention;

FIG. 3 depicts a two tier implementation (in PLC rack) of communication from an RFID reader to enterprise level according to a second embodiment of the present invention;

FIG. 4 depicts a two tier implementation (standalone) of communication from an RFID reader to enterprise level according to a third embodiment of the present invention;

FIG. 5 shows the internal components of the RFWise component of the present invention;

FIG. 6 shows the functions of the RFWise components at runtime;

FIG. 7 illustrates the structure of the type of information presented to a user by the configuration tool of the present invention;

FIG. 8 shows the functions of the RFWise components during configuration;

FIG. 9 shows the internal components of the RFWise component of the present invention modified to accommodate multiple readers;

FIG. 10 depicts an implementation of the present invention for virtual device support;

FIG. 11 illustrates a sample configuration screen in accordance with the present invention;

FIG. 12 depicts and implementation of the present invention for secure RFID tag encryption and certification exchange; and

FIG. 13 depicts the RFID tag data fields.

### DETAILED DESCRIPTION OF THE INVENTION

Companies are adopting RFID tag readers into their businesses. As this tag data becomes available, it has to be both read and shared with other business applications in areas such as inventory tracking, warehouse automation, dock door control, ERP (enterprise resource planning) and MRP (manufacturing resource planning). This same RFID information is required by some users to be used by the plant floor PLCs. The present invention provides means to improve the integration process between the RFID reader and the enterprise level, include RFID information in PLCs, and to add additional security to future RFID tag systems.

As used herein, the following terms shall have the following meanings:

“Backplane”: Hardware communications bus in, for example, a reader or in a PLC.

“DeviceWISE”: A software communications module product as described in U.S. patent application Ser. No. 11/142,200 entitled “Model for Communication Between Manufacturing and Enterprise Levels”, filed Jun. 1, 2005,

“RFID”: Radio Frequency IDentification.

“RFID reader”: The antenna and host system used to pick up tag information.

“RFID tag”: The active or passive RFID tag that is attached to the item to be tracked.

“Chip RFID”: An RFID tag with a silicon chip that allows additional capability to be onboard the RFID tag.

“Active RFID”: An RFID tag with a battery or other power source that allows the tag itself to broadcast information.

“Passive RFID”: An RFID tag with no power source imbedded therein. Power to respond comes from wire arrays that are stimulated by the RFID reader antenna.

“PLC”: Programmable Logic Controller. An input/output device used to do simple control of plant floor “tools”, such as photo-eyes, conveyor belts, robots, status lights, sensors, etc.

“RFactor”: A combination of the RFWise software components installed on embedded hardware or edge controller hardware.

“RFWise”: A software component of the present invention described herein.

Various embodiments of the present invention are discussed in detail below. While specific exemplary embodiments are discussed, it should be understood that this is done for illustration purposes only. A person skilled in the relevant art will recognize that other components and configurations can be used without departing from the spirit and scope of the invention.

Intelligent Reader

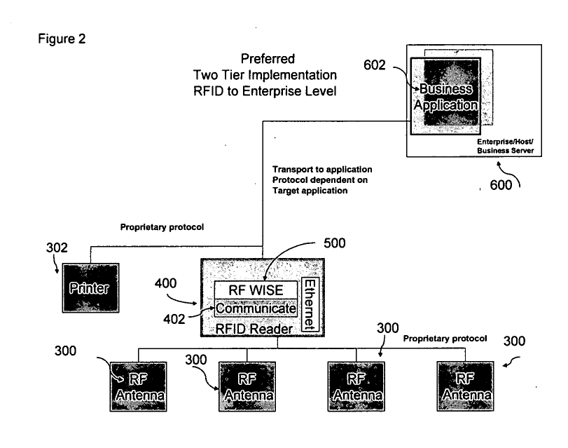

FIG. 2 depicts an implementation where RFWise software 500 has been installed in the reader 400 itself to allow for direct and easy movement of reader information up to the enterprise level 600. This integration is built on DeviceWISE technology; see U.S. application Ser. No. 11/142,200 entitled “Model for Communication Between Manufacturing and Enterprise Levels”, the entire disclosure of which is incorporated herein, for details of the transports available. DeviceWISE is a software framework that provides intelligent and secure connectivity from, for example, a plant floor device to an enterprise. DeviceWISE allows connectivity to any device in a vendor neutral methodology to an enterprise level, allowing real time decisions based on real time data to be made. DeviceWISE includes a drag and drop configuration tool which allows programming to move data from devices to enterprise databases or applications or queues without java.

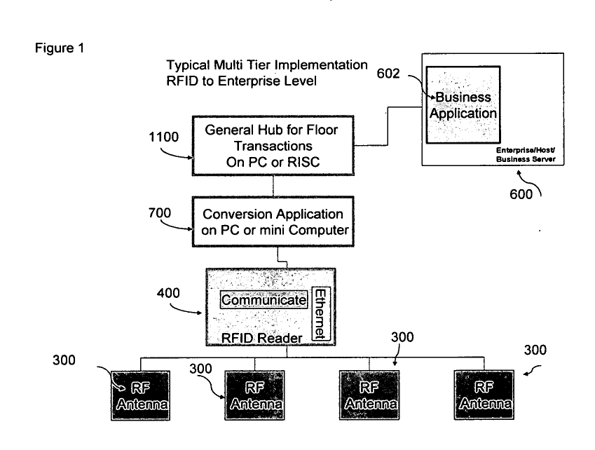

In FIG. 2, an RFID tag passes near an antenna 300 of the reader 400, and that information is passed in a proprietary format to the RFID reader 400. In this case, the RFID Reader 400 is an “intelligent” reader which allows for applications to be embedded therein. The inventive software, RFWise 500, is installed on the reader 400 to carry out functions which replace the intermediate PCs 700 and 1100 in FIG. 1. The RFID tag information is passed from the internal communication module 402 of the intelligent reader 400 to the RFWise software module 500. The RFWise software module 500 then processes the information according to local business rules or logic incorporated in the software and decides if the information is to be passed to the business system 602 at the enterprise level, and also decides which business system 602 will be contacted. The RFWise module 500 sends the information to the business system 602 via a standard protocol, such as ODBC, JDBC, CLI, Oracle, DB2, OPC, JMS and/or MQSeries, etc., for use by the business application 602. The protocol used by the RFWise module 500 will be dependent on the target business application 602. In one form of the present invention the business application 602 may be a PLC, which can use the RFID tag data in local manufacturing control applications. In that event, the RFID tag data may be pushed into the PLC memory via a PLC remote communication link.

Based on the local logic in the RFWise module 500 in the intelligent reader, 400, a decision to print a label (RFID or barcode) could be also made. In that case, the RFWise module 500 sends a signal to a locally attached printer 302 with the information to be printed. Typically, this information will be sent to the from the reader 400 to the printer 302 via the printer's 302 proprietary protocol.

A configuration tool is used to choose sections of the RFID data fields for mapping into different variables, such as into a JMS message or into columns and tables in a DB. Configuration information is discussed in more detail later in this description.

In Rack RFID

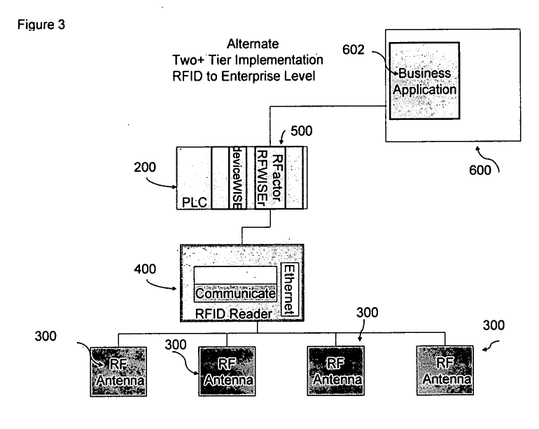

FIG. 3 shows an implementation of the RFWise software 500 in a PLC module 200 instead of in the RFID reader 400. All functions operate the same, but the RFWise software 500 also includes a device driver to talk to the RFID reader 400. There are two options for this type of configuration, namely, reader 400 to PLC 200 only, and reader 400 to both PLC 200 and enterprise level 600. As shown in FIG. 3, when going to the enterprise level 600, software functionality from the DeviceWISE product is also included in the PLC 200.

In operation, an RFID tag passes near one of the antennas 300, which sends the data in a proprietary format to the RFID reader 400. In the embodiment of FIG. 3, the reader 400 is a standard reader available today, and will either wait for a poll from an outside system or send the data upstream to a connected system. In FIG. 3, the RFWise software 500 is embedded in the PLC 200, typically on a card or other module, such as, for example, an RFactor module, and has a connection via a device driver (not shown) to the RFID reader 400. The reader 400 sends the RFID tag information to the RFWise module 500, where it is analyzed according to local business logic, and then two different actions may take place.

The RFID tag information may be sent from RFactor/RFWise module 500 to the business applications 602 at the enterprise level 600 via a standard protocol. In addition, the RFID tag information may be pushed into the PLC 200 CPU memory for use in local manufacturing control applications. This communication happens via the PLC backplane API communication typically provided in the PLC rack.

Two Tier RFID

There can be several implementations of the two tier connectivity described herein, including a module that mounts in the PLC rack or a plant floor edge controller computer that contains the system for those sites that do not have PLC racks.

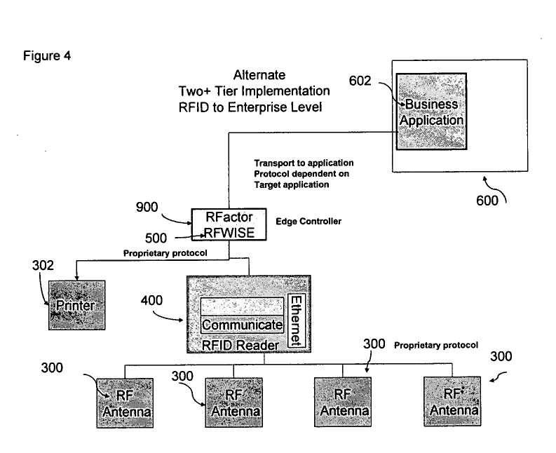

FIG. 4 shows an implementation similar to that of FIG. 3 for those customers that want the ease of use and configuration but do not have PLCs or intelligent RFID readers in which to install the inventive solution. In this embodiment, the RFWise software 500 is installed in a small minicomputer, or edge system/controller 900.

In FIG. 4, the RFID tag information read by the antennas 300 is sent, via a proprietary protocol, to the standard RFID reader 400 and is then sent to, or polled from, the RFWise software 500 located in the edge controller 900, where.it is analyzed according to local business rules and logic. The RFID tag information may then be sent from RFactor/RFWise module 500 to the business application 602 at the enterprise level via standard protocol, such as ODBC, JDBC, CLI, Oracle, DB2, OPC, JMS and/or MQSeries, etc., for use by the business application 602.

Based on the local logic in the RFWise module 500 in the edge controller 900, a decision to print a label (RFID or barcode) could be made. In this case, the RFWise module 500 sends a signal to a locally attached printer 302, via a proprietary protocol, with the information to be printed.

An advantages of this edge controller configuration of FIG. 4 over the PC configuration shown in FIG. 1, is that the inventive software tool allows for a drag and drop integration, rather than specialized programming. Also, the operating system for the edge controller is generally a Linux derivative, which provides better stability than the Windows PC environment typically used in the embodiment shown in FIG. 1.

Invention Internal Components

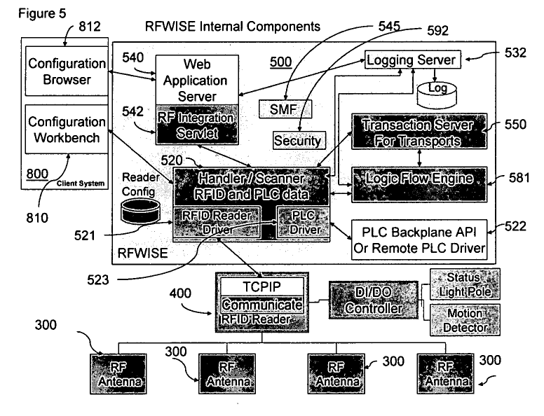

FIG. 5 shows the internal components of the RFWise software module 500 for integrating RFID information into various devices including, for example, intelligent readers, PLCs and/or small edge controllers. The main components of the system are:

(1) The Handler/Scanner 520, which communicates with: (a) the RFID reader 400 to gather or write data; (b) the backplane API 522 to read and write PLC variables; (c) the transaction server 550 to send and receive data from the enterprise business applications 602; (d) the internal logging server 532; (e) the integration servlet 542; and (f) the logic flow engine 581 for the execution of local business logic.

(2) The logic flow engine 581, which performs local data manipulation and implements business rules.

(3) The transaction server for transports 550, which communicates with the enterprise and control applications.

(4) The web application server 540, which lets the system manage data to be shared with a browser (configuration data, logs, etc.).

(5) Device drivers for PLC 523 and RFID Readers 521.

(6) System management tools, such as SMF 545.

(7) Configuration tools, based on a client workbench 810 or based on a browser 812.

Additional components include:

(8) SMF 545 for system management and update of all components remotely.

(9) Security 592 for handling encryption and details related to tag security.

Component Interaction at Runtime

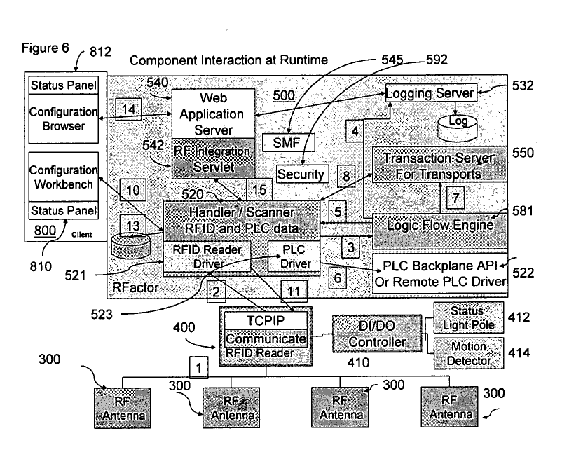

FIG. 6 shows the components of the RFWise software 500 during a typical operation. An RFID tag passes near one of the antennas 300, which reads the data on the tag and sends it, via connection 1, in a proprietary format to the RFID reader 400. The reader 400 sends the data in another proprietary format, via connection 2, to the RFID driver 521 in the RFWise software module 500. The data is then passed to the logic flow engine 581, via connection 3, where local business logic processing is performed on the data. The data may be reformatted by the logic flow engine 581 for its target application, and it is sent from there to the transaction server 550, via connection 7, for routing to the business application 602. The resulting data may also be sent from the flow engine 581 back to the handler/scanner 520, via connection 5, for sending, via the PLC driver 523 and connection 6, to the PLC backplane API 522 and into the PLC's 200 CPU memory for use by the PLC applications. Data that is sent to the PLC 200 is written into predefined registers/data structures on the PLC 200. The context of which tags are still awaiting processing and which are already “stored” is maintained in RFWise application memory.

For the connection number 2 between the reader 400 and the reader driver 521, the reader 400 can either push data to the reader driver 521, or the reader driver 521 can poll the RFID reader 400 for information, depending on the capabilities the manufacturer provides. The reader driver 521 publishes the tag events via the handler/scanner 520 to any interested parties (logic flow engine, status screen, audit systems, raw to PLC queue), as shown by connections 3, 6, 8 and 15.

In operation, the user may have specified that the business rules require logging. In this case, connection 4 between the logic flow engine 581 and the logging server 532 would be invoked to store information. There are two types of logging they may be done, namely, standard event based logging and user requested logging. The explicit user-requested logging allows the user to request logging at an event or logic action. This allows the user to look at logs to search for any information they may need. The configuration of the use of the logging utility is handled in the logic configuration (logic composer) portion of the configuration utility. Logging is also used by other components in the system.

For data that needs to be moved to the enterprise level 600, the data is moved from the logic flow engine 581 to the transaction server for transports 550, via connection 7. This component of the overall system allows the data to be transferred to enterprise applications, such as, but not limited to, DB2, Oracle, MQ Series, My SQL, TCPIP sockets and JMS. More details of this feature are described in the deviceWISE patent application (Ser. No. 11/142,200), which is hereby incorporated by reference herein.

Logic Flow Engine

The logic flow engine 581 is used to do basic business logic and processing at the RFWise level, as opposed to performing all logic at the enterprise or intermediate PC level. This reduces network traffic, allows for a more efficient use of systems, and removes communication delay while waiting for a response from processing at a different level. The functions of the logic flow engine 581 include:
User configured pre and post processing of data.
   Do part of a business requirement before gathering data and after retrieving data.
Handling of simple and complex mathematical processing.
   Sums, differences.
   Average, standard deviation.
Other data manipulation.
   Swap items in a string list to match a business application.
   Bit manipulations.
Interact with other devices based on an event.
   Retrieve additional information from other devices to complete the data gathering for a particular event.
Aggregate data from devices for sending to host.
   Put together data from several operations.
   Put together data from several locations.
Aggregate data received from host for local operations.

For RFID data, there may be a set of critical items that are expected to be delivered. There can be a logic function which receives a list of these “hot items” so that when they are seen, a special indicator can be provided to let the operator know to move these items directly to the sales floor or manufacturing assembly floor because they were out of inventory.

For assembly operations, there may be a trigger at the completion of a particular step where the completed part is read. This may launch a logic flow to collect other information about that part in the last few stations to send it together to the business application at the enterprise level.

When data is to be sent from the manufacturing floor to the enterprise business application, the format of the data in the two systems is often mismatched. At some point, the data collected needs to be manipulated to match the receiving application. The logic flow engine 581 can do this manipulation so that corrected data is sent.

To verify the contents of a pallet, RFID data may be collected. Since in many applications each RFID tag is serialized and unique, the system can look for, for example, twelve cartons of a product on a pallet. If there are not yet twelve cartons present, it can flag an error with the packing or with the tag itself. This logic can stay down at the local level and not cause traffic up to a control system. When corrected, the fully loaded set of pallet data can be sent to the business application at the enterprise level as one transaction.

Control of the local environment and business flows can be done by the logic flow engine 581. The reader antenna 300 may stay off to conserve power and reduce RF interference with the equipment, until such time as the operator is ready to initiate a read and moves product into the read zone. The logic flow engine 581 can integrate to a motion detector to sense presence, then turn on the antenna 300, check to make sure the correct number of parts were read, send a signal to the operator that the read was complete, and turn the antenna off and send the correct data to the enterprise level business application.

An implementation of the above example is as follows. The motion detector 414 senses the presence of a fork truck, box, or tag and sends a signal to the DI/DO controller 410 in the RFID reader 400. This then tells the RFID reader 400 to turn on power to the antennas 300, and to read the RFID tag information. This data is sent via connection 2 to the RFWise software 500 for processing. If the read tag data passes the business logic in the flow engine 581, as described previously, a signal will pass back down to the RFID reader 400, instructing the reader 400 to turn on a green light on the status light pole 412, via the DI/DO controller 410, so the operator will know there is a successful tag read. A light is but one indication means of a successful read and any other visual (e.g., screen update) or audible (e.g., buzzer) signal may be used as an indication means. Additionally, a PLC status change or PLC device variable change (e.g., open a door, change a conveyor, etc.) may also occur as a result of a successful read.

PLCs may collect assembly information for several components, such as, for example, assembly torque for six pistons. This data can be analyzed and averaged and the data sent to the enterprise business application as one set of data for one engine. The logic flow engine 581 has the ability to control the overall set of processes. Each flow has a priority level so that the business items will not be slowed down by regular maintenance items.

The RFWise system can be set to watch the value of a particular variable in the PLC or in the incoming RFID tag information and trigger a flow based on the event of that data reaching a threshold or matching a predefined number. In addition to being able to trigger logic flows from local events, logic flows can also be triggered from other logic flows, or on a predefined schedule. To improve the performance of the system and improve the ease of use to create to new logic, logic flows can be defined as “sub flows” so that they can be reused and called by other logic flows.

Each flow can be given a unique version so that back level versions of flows can be retained (inactive) in the system so that the user can revert to a previous level on demand. The same flow can have multiple instances running concurrently with different data.

The flow engine composer (or workbench) has a drag and drop user interface, making it simple to create business logic without formal program development with C or Java. The logic flow engine 581 is not dependent on the Windows operating system or any particular operating system, so it allows it to run in multiple locations, for example, in a reader, PLC, etc.

As previously noted, a component of the overall system is the logic flow engine 581 which allows the end user to define a set of business rules or work flows that are applied to the data. These rules are generally applied to the data as it comes into the system to provide, for example, appropriate filters, and they are applied again based on activities that happen at given events. The flow engine 581 receives this and performs an analysis of the data to determine where the data should be stored, and also if the data should be parsed and manipulated prior to usage.

This type of operation is important in several examples. In the case of a dock door operation, it is good to be able to download a set of “watch tags” for which the reader 400 can be looking to signal that as soon as these tags or parts are identified by the RFID system they need to be transferred immediately to the manufacturing line or the sales floor for immediate use. By having the ability to contain logic at this lower level, instead of at the PC level as is currently done, connections to the main network can be lost periodically without affecting the overall operation.

In another example, local processing is also important to be able to continue if connections to control applications are lost. In the case of medical activities, there are certain prescribed drugs for certain patients. If this information is downloaded to the lower level system, local alerts can be made immediately to the nurses to indicate whether or not the drug scanned is to be used on the patient that was scanned. Moving the decision and processing power down closer to the point of usage removes system delays and improves overall system availability.

For example, one read may come in and should be placed on dock door I queue, while another read man come in, be parsed to separate fields, and be stored in the PLC data arrays for dock door 2 part number and dock door 2 model number data entries

Another example could include the logic engine 581 examining the tags that are coming in and comparing them to lists that are predefined. If these tags match a “black list”, a different action takes place, such as signaling an I/O device, which could be the status light pole 412 attached to the reader 400 or a data tag to signal an event in a PLC. For example, once a light beam is tripped, the reader 400 scans for three seconds, and if there is a number of good reads, then the status light 412 is lit green and, if not, it is lit red.

The movement to the storage area in the PLC can happen in two different modes, namely, raw and processed modes. In the raw mode, the data is moved directly into the PLC queue (data array). In the processed mode, the data moves first to the logic engine 581 which determines if the appropriate rules have been met for that data to be placed into a PLC queue (data array). This allows the users to filter duplicate data and to apply other hardware independent filtering rules. This is important in the industry as each reader vendor has a different set of tag attributes and filtering techniques. This processing is done in the logic flow engine 581.

Configuration

Configuration of the system consists of several parts. These include:
Setup of the readers themselves, which includes:
   Naming/aliases of readers and antennas;
   Set local filtering;
   Set auto mode for how to respond to an activity; and
   Other reader functions as provided by the particular vendor;
Identification and implementation of the data structure that is to be used in the PLC to store the RFID tag information;
Configuration of any business rules that are necessary before data is moved to the PLC or another enterprise application;
Parsing the tag information into separate pieces;
Identification of where data is to be sent and in what format, which includes:
   Definition of the mapping of the data between the read format and the desired format;
Filtering of tags based on comparisons of data to predefined values; and
Logging.

These configuration functions can be provided to the end user with two different mechanisms, either a client application or through HTML screens. The primary function in this environment will be to set filtering rules for the information. However, other capabilities, such as setting PLC tags, sending information to the enterprise level, logging, data manipulation (mathematic operations), changing reader configurations based on conditions in the plant or the data, etc., can also be controlled with the logic flow engine 581. These options are presented to the user in flowchart manner so that they can drag and drop various functions to the flowchart and add detailed parameters to it.

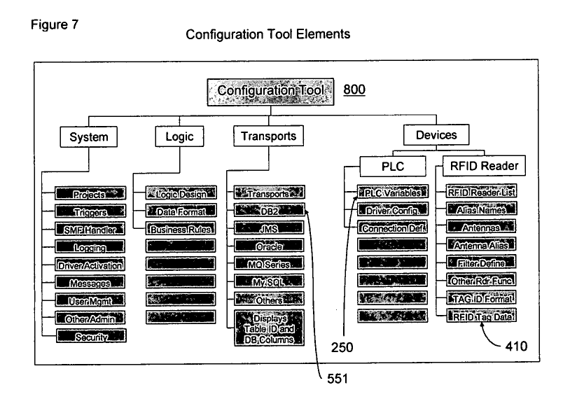

FIG. 7 shows a structure of the type of information that is presented to the user. Most of this information is displayed to the user in a tree format where the user can drag and drop data elements or simple logic elements to create associations and rules between the different pieces. For example, the user can drag an RFID tag field 410 to a variable name in the PLC 250 and indicate when this write action should take place. The user can also drag an RFID tag value 410 to, for example, a DB transport Table Name/Column name 551 to define where a tag value will be stored on the business application side. This provides a simple integration technique between elements that previously required specialized code to link them together.

Data, status and configuration information generated in, or available from, the RFWise system can also be accessed via a standard web browser.

In the case of reader configuration, all RFID readers have the ability to telnet to them and make changes to set different options, such as, for example, persistence of tags, reads, active antennas, sensitivity or attenuation of the antennas, reader name, reader address, open ports, mode if publishing or if active read is required (get versus publish). These parameters are usually established through a telnet session and a command line interface where details are typed into the reader.

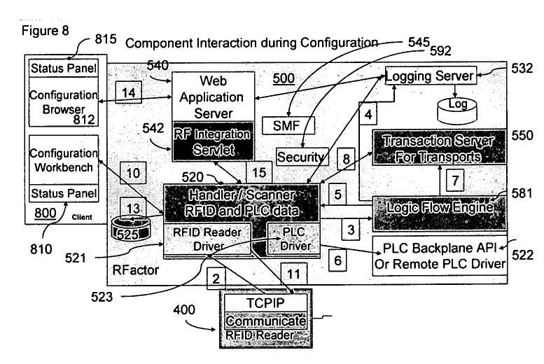

As shown in FIG. 8, the RFWise configuration tool 800 provides a simple interface (either application workbench 810 or browser 812) that allows the user to set the standard parameters through a graphical interface rather than a telnet session. The configuration tool 800 then communicates this information to the reader 400 through a TCPIP connection 10, which is established through the handler/scanner 520, and then to the reader 400, via connection 11. An extension of this tool scans the network for readers during initialization and presents a list of readers to the end user for configuration. The automatic reader discovery capabilities in the configuration tool are selected by choosing a network subnet to scan.

Through the configuration interface, a user can define an array of information in the PLC that can be used as a queue for storage of recent RFID reads. In FIG. 8, the configuration tool 800 connects to the handler/scanner 520, which connects to the PLC driver 523, and then to the PLC backplane API 522, to send the defined array signal to the PLC 200.

In FIG. 8, the configuration tool 800 will also have to set information for the logic flow engine 581. Commands from the configuration tool 800 are sent to the handler/scanner 520, via connection 10, which sends them to the flow engine 581, via connection 3.

RFID tag information typically has a field of 96-bits of information that is treated as a long field by the reader. This information can be defined differently by each tag writer and there is usually a convention between customer and vendors as to what information is stored. For example, the first 10-bits may be a part number, while the next 10-bits may represent the model, and the next 10-bits may represent the serial number or another category. For this information to be useful to applications, it should be separated or parsed into the individual pieces. The configuration utility 800 allows the end user to quickly pick the individual bits or groups of bits and assign them to a local data variable or PLC data tags for use. The logic engine 581 functions will then do this separation at run time and store them appropriately.

In order for this approach to work effectively, the RFWise configuration tool 800 may assist with the definition of the data within the PLCs 200. For example, an RFID tag comes in and goes to a PLC tag array. A field on the PLC side is a specially constructed structure that conforms to the data structure of the RFID tag. All tags in any given reader have the same structure, and the user can choose to use this native format or use a normalized format that is common between the different readers.

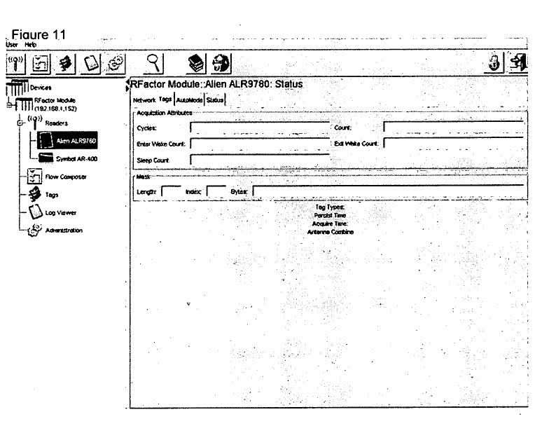

A sample configuration screen is shown in FIG. 11. There are two versions of the configuration utility, namely, browser based using the configuration browser 812 and application based using the configuration workbench 810 (see FIG. 8). In the case of an application based configuration tool 810, the user works on their client workbench application, which interacts, via connection 10, to the handler/scanner 520. Reader configuration is then translated to the appropriate protocol by the handler/scanner 520 (via the reader driver 521), and communicated to the reader 400 via connection 11. The reader 400 then stores this configuration and uses it for operation. The details of this configuration are also persisted by the handler/scanner 520 and connection 13 to a storage location 525 within the RFWise system 500.

In the case of a browser based configuration tool 810, the user works on their client workstation, which interacts, via connection 14, to the web application server 540 and the RF servlet 542. This information is then sent to the handler/scanner 520, via connection 15. The reader configuration is then translated to the appropriate protocol by the handler/scanner 520 (via the reader driver 521), and communicated to the reader 400 via connection 11. The connection between the reader driver 521 and the reader 400 may be one of several protocols, for example, serial, tcpip or backplane. The reader 400 then stores this configuration and uses it for operation. The details of this configuration are also persisted by the handler/scanner 520 and connection 13 to a storage location 525 within the RFWise system 500.

Status

The overall status of the system is also available to the end user via a status panel 815 in the configuration tool 800, as shown in FIG. 8. The status panel 815 can provide information on, for example, what is going on in the reader, the number of tags that have come through, value, time stamps, state of reader, time clock on reader, general status of the reader, etc. The status panel 815 also allows the user to look at the connection status to see what is still actively operating.

The status panel 815 can also allow the user to look at active data in the PLC 200 and the latest data from the RFID readers 400. The data in the PLC queues can be monitored to view the activity of the system. The user can also track the business logic flow status (running, stopped, last time run, etc.). The status panel 815 can also be used to view logs.

Analogous to the other parts of the configuration utility 800, the status panel 815 can be either an application or a browser based utility. If application based, the user client 800 talks directly to the handler/scanner 520 for information, via connection 10 as shown in FIG. 8. If the browser option is used, the status panel 815 connects to the web application server 540, via connection 14, and then to the handler/scanner 520, via connection 15. The web application server 540 may optionally be a basic web server.

Reader Multiplexer

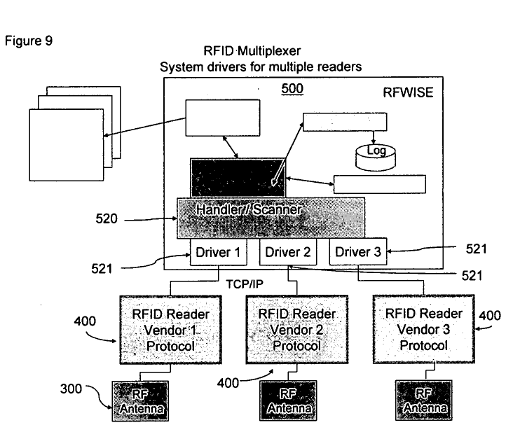

As shown in FIG. 9, the handler/scanner reader device drivers 521 can be customized for any number of readers 400 available in the marketplace. Each of these readers 400 may have its own data structure, protocol and handshaking methodology for communication. In this form, the handler/scanner 520 includes multiple reader drivers 521 which are capable of communicating. with the particular reader 400 using the protocols of that particular reader. The RFWise solution of multiple reader drivers 521 can be used to insulate these differences between various readers that may be utilized. Multiple readers from different vendors can thus be connected to the same RFWise system 500.

Normalized Activity Drivers for RFID Readers

Usage of a “normalized” data structure provides the user with the ability to swap out different reader hardware with no change to applications. Two types of data structures that can be supported are: (1) each company's native record format for data; and (2) normalized mode (least common denominator), where common data structures are used as the local standard. If a logic application was created using all the data and native data structures from a particular reader, this code would have to be updated if the company changed reader providers. By using the normalized data, the applications are transferable across locations where different reader hardware may be used. For example, an Alien™ reader provides: tag information, antenna from which it was read, time-stamp at detection, and time stamp at last read. A Symbol™ reader provides: tag information, antenna from which it was read, time stamp at last read, and tag read zone. An Intermec™ reader provides: tag information, and antenna from which it was read. A normalized version of this data can contain, for example, tag information, antenna from which it was read, time-stamp at detection, time stamp at last read (filled in by local software if not provided by the reader), and tag read zone.

Despite the advantages of using normalized data, the inventive RFWise system will still allow the users to maintain native data structures concurrently in the same RFWise system. Each reader information would have to go to its own logic flow to maintain data structures. In either case, the internal communication used by the handler/scanner is a standard interface to the drivers for the RFID readers.

Virtual Device Support

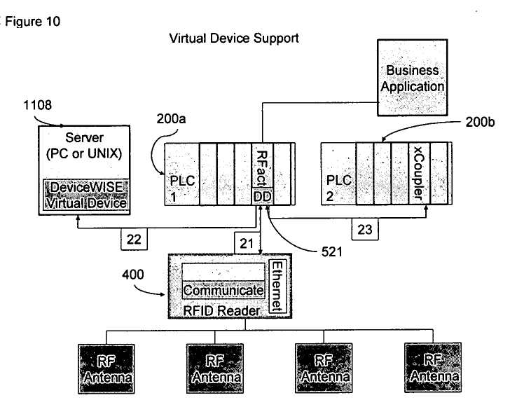

The reader drivers 521 that work with the handler/scanner 520 can publish to any number of other system components on that module or on a remote module. This means that other systems can receive data from the RFWise drivers in a remote location. As shown in FIG. 10, the RFWise handler/scanner device driver (DD) 521 in PLC 200a (1) is. communicating with the RFID reader 400, via connection 21, to obtain tag read data. This same data is then published to another server 1108, via connection 22, and to another PLC 200b (2), via connection 23. This connectivity between various components improves overall efficiency of the system, allowing more information to be shared with less upstream programming.

Security

There are two main areas of security in the inventive system: (1) access to the different components relative to an individual's particular authorization level; and (2) RFID tag information security to prevent unauthorized reads.

Relative to the controlled usage of the different parts of this system, there is controlled access based on the user's authorization level. Some users will have access to set antenna parameters, while others will only be able to view data from them. Each reader 400 may only be able to be accessed by a subset of users. The logic flow engine 581 also runs in the context of user authorization, allowing only certain functions (read, update, transport, email, etc.) to be used depending on the authorization level of the user. Flows might involve talking to output devices on the floor, such as status lights 412. Users would only be able to send commands to those devices for which they have been given privileges.

For transporting data to the enterprise level 600, there are a variety of different transports, such as, for example, DB2, Oracle, MQSeries and TCPIP. Access to these transports is also controlled by security levels. Accessing and updating are considered different levels of security. A user may be able to request a read of data from a particular RFID reader, but not be able to modify the read parameters of that particular RFID reader.

Secure RFID Tags

Tag data structures are typically set by the manufacturer (for example 64, 96, 128-bits long, or more). Each user can define the usage of this space as one single number, or can partition the bit string and utilize sets of these bits for certain information. For example, one customer may define that the first 10-bits of the tag contain a part number and the next 86-bits contain a short description. This customer can then parse the tag information to get the separate part number (10-bits) and description information (next 86-bits). Any reader can pick up the same broadcast 96-bits of information. In many cases, this tag is transported out of the user facility via truck (such as on a package, part or finished product). Since these tags can be read from a distance, the content of the truck can be known by any “strange” reader that is looking for data. In some cases, the description information contained in the RFID tag data may be sensitive and should not be readily shared with outsiders.

As an extension of the present invention, the RFID tag data can be encrypted to protect information from unintentional disclosure. Since large retailers will receive products from many suppliers (each with its own RFID tag), a key exchange mechanism must be supported to allow a read at the original supplier location and at the retailer location. Therefore, the tag data definition convention will include a set number of bits in the tag that are sent “in the clear” to identify the tag source. Based on that information, the appropriate decryption key or de-hashing algorithm can be chosen to decrypt the tag information.

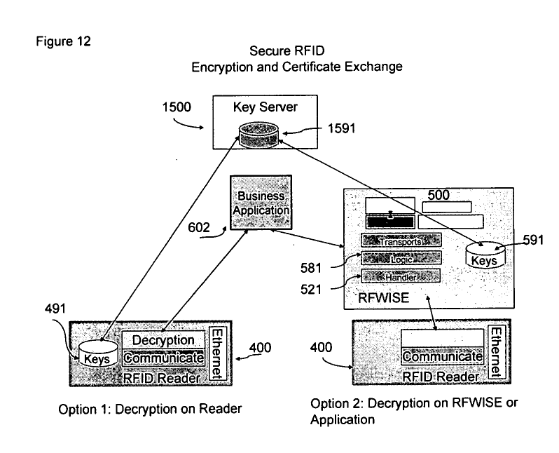

The key storage and decryptions routines can be handled at the reader level or at the application level above the reader. FIG. 12 shows an example of each configuration. Option 1 has the key information and decryption tools installed on the reader 400, while Option 2 shows these tools on the RFWise system 500.

In the inventive RFWise implementation, the logic flow engine 581 reads the vendor ID information from the tag data and looks at the key storage table 591 to determine the appropriate key, or seed, and algorithm to use for decryption. After the data is decrypted, it is passed to the rest of the system for use in the PLC or transmitted to the business applications 602.

The key table can be located in a number of locations depending on customer preferences. For example, the key table can be located on the reader 491, in the attached application 591, or in a central location 1591. These can be used individually or in combination where there is a central store and local replications.

In the example where the key table 1591 is maintained at a central location 1500, the key data in the key table 1591 can be distributed to the individual readers or can be maintained locally and the reader or application would request key information at tag usage. The table 1591 includes a list of vendor ID numbers and their corresponding key information for decryption.

There are two basic encryption methodologies that can be used in this solution, namely, encryption algorithms with keys or general hashing algorithms. In each case, the supplier and retailer exchange the methodology and keys, or seed numbers, and algorithms so that the data can be unencrypted at the receiving side.

As the standard tags change over time and provide additional data lengths (e.g., 256-bits and larger), more complex security can be added, including access via certificates. This would allow the system to go beyond the key methodology described above and include signing so that the receiving group knows the key is authentic and has not been tampered with.

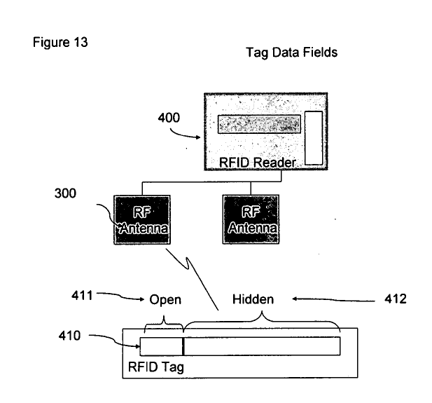

An alternative to the encryption only security described above, is the additional layer of processing at the RFID tag layer itself. As tags become more sophisticated, even passive tags can provide some processing capability as the antenna provides power for them. In such future extensions, the RFID tag itself can be created to perform a simple logic checking. Any reader trying to read would be only able to read the unencrypted tag “header” information. Then the reader would have to send authentication information to the tag before the tag would respond with the remainder of the information stored on it. This response could be in encrypted form which would require further decryption. A summary of this is shown in FIG. 13, where the “open” 411 part of the RFID tag data 410 is sent upon initial request. After receiving additional credentials (certificate, password, key, etc.) from the RFID reader 400, and doing logic checking at the tag level, the remainder of the “hidden” 412 part of the RFID tag data 410 would be transmitted to the RFID reader 400 if the authentication was successful.

System Health Monitor Parameters

The overall system has data variables associated with how the system itself is running. The flow engine 581 could be used to write business rules to allow the users to write a rule which queries how the system is doing and take action based on those parameters. For example, if connection is lost to a particular RFID reader, that reader can be stopped and an alternate RFID reader can be started at that location as a means for primary failover. The flow engine 581 could also contain logic to create a notification e-mail to be sent to a maintenance technician relative to the failure. The failover would also be logged so that the cause of the failure could be traced.

The examples contained in this description of the present invention are based in the manufacturing domain. One skilled in the relevant art will appreciate that the present invention can also be applied to many other domains. For example, in the medical field, RFID is being used to track personnel and equipment in hospitals. Intelligent readers or edge controllers containing RFWise can be used to help create applications that provide for better drug dispensing by checking the patient name against the drug scanned (RFID or barcode) to ensure correct chemicals and patient dosing.

While the present invention has been described with particular reference to the drawings, it should be understood that various modifications could be made without departing from the spirit and scope of the present invention.

The following set of claims is not limiting, but is merely exemplary of preferred aspects of the present invention. It is to be understood that the present patent application instead covers all aspects of the present invention as shown and described herein.

We claim:

1. A system for communicating RFID tag data from an RFID reader to an enterprise level business application, said system comprising:
an RFID reader having one or more RF antennas operably coupled thereto for detecting RFID tag data; and
software installed on the RFID reader, wherein the software can: (a) process the RFID tag data, (b) decide if the RFID tag data is to be passed to an enterprise level business application and which enterprise level business application it should be passed to, and (c) transmit the RFID tag data directly to the enterprise level business application based on the decision in (b).

2. The system of claim 1, wherein the enterprise level business application comprises a PLC.

3. The system of claim 2, wherein the RFID data is pushed into the PLC memory via a PLC remote communication link.

4. The system of claim 1, wherein said software can decide to print a label (RFID or barcode) and send a signal to an attached printer with the RFID tag data to be printed.

5. The system of claim 1, wherein said software includes local business rules and/or logic installed thereon, and wherein said software processes the RFID tag data according to the local business rules and/or logic.

6. The system of claim 1, wherein the RFID tag data is sent to the enterprise level business application via a protocol selected from the group consisting of but not limited to ODBC, JDBC, CLI, Oracle, DB2, OPC, JMS and MQSeries.

7. The system of claim 1, where said software comprises:
a handler/scanner module receiving the RFID tag data;
a logic flow engine module receiving the RFID tag data from the handler/scanner and executing and applying local business rules and logic to the received RFID tag data; and
a transport server receiving the RFID data from the logic flow engine and transmitting the RFID tag data to the enterprise level business application.

8. The system of claim 7, wherein the logic flow engine decides if the RFID tag data is to be passed to an enterprise level business application and which enterprise level business application it should be passed to, and wherein the logic flow engine reformats the RFID tag data in accordance with its target enterprise level business application.

9. The system of claim 7, wherein the handler/scanner decides if the RFID tag data is to be passed to an enterprise level business application and which enterprise level business application it should be passed to, and wherein the handler/scanner reformats the RFID tag data in accordance with its target enterprise level business application.

10. The system of claim 7, wherein the handler/scanner includes a reader driver receiving RFID tag data from the RFID reader.

11. The system of claim 10, wherein the reader driver polls the RFID reader for RFID tag data.

12. The system of claim 7, wherein said software further comprises a logging server receiving and storing information in a database.

13. The system of claim 7, wherein the RFID reader includes means for providing an indication event of a successful read, wherein the logic flow engine instructs the handler/scanner to activate the indication means upon a successful RFID tag read.

14. The system of claim 13, wherein the indication means is selected from the group consisting of a visual indicator, an audio indicator, a PLC device status change, a screen update and a PLC device variable change.

15. The system of claim 7, wherein the handler/scanner includes a plurality of reader drivers receiving RFID tag data from a plurality of RFID readers.

16. The system of claim 15, wherein each reader driver is connected to one RFID reader and communicates using the protocol of the RFID reader to which it is connected.

17. The system of claim 7, wherein the RFID tag data is encrypted prior to transmission to the RFID reader, and wherein the logic flow engine decrypts the RFID tag data according to a decryption key.

18. The system of claim 17, wherein the RFID tag data includes a set number of bits that identify the tag source, and wherein the logic flow engine determines the appropriate decryption key based on the set number of bits identifying the tag source.

19. The system of claim 18, wherein the logic flow engine selects a decryption key from a key storage table based on the set number of bits identifying the tag source, wherein the key storage table includes a list of vendor ID numbers and corresponding key information for decryption.

20. The system of claim 7, wherein the software includes one or more configuration tools containing a record of all defined projects, transports and general setting, and wherein the software can reset itself to a previous setting using the configuration tools upon recovery from a power failure condition.

21. The system of claim 20, wherein the configuration tools provide information to a user in a tree format, wherein the user can drag and drop data elements or logic elements to create associations and rules between different elements.

22. The system of claim 20, wherein the configuration tools scan for active RFID connections at initialization and present a list of active readers to a user for configuration.

23. The system of claim 20, wherein the configuration tools allow a user to define a set of rules to apply before transmitting the RFID tag data.

24. The system of claim 23, wherein the set of rules includes not to take repeat reads, look for a range of acceptable information before reporting, and define a trigger to turn a reader on.

25. A system for communicating RFID tag data from an RFID reader to either an enterprise level business application or a PLC, said system comprising:
an RFID reader having one or more RF antennas operably coupled thereto for detecting RFID tag data;
a PLC in communication with the RFID reader and receiving RFID tag data from the RFID reader; and
software installed on the PLC, wherein the software can: (a) process the RFID tag data, (b) decide if the RFID tag data is to be passed to an enterprise level business application and which enterprise level business application it should be passed to, (c) decide if the RFID tag data is to be pushed into a memory of the PLC, and (d) either transmit the RFID tag data directly to the enterprise level business application or push the RFID tag data into the PLC memory based on the decision in (b) and (c).

26. The system of claim 25, where the RFID data is pushed into the PLC memory via a PLC backplane API communication link.

27. The system of claim 25, wherein said software can decide to print a label (RFID or barcode) and send a signal to an attached printer with the RFID tag data to be printed.

28. The system of claim 25, wherein said software includes local business rules and/or logic installed thereon, and wherein said software processes the RFID tag data according to the local business rules and/or logic.

29. The system of claim 25, wherein the RFID tag data is sent to the enterprise level business application via a protocol selected from the group consisting of ODBC, JDBC, CLI, Oracle, DB2, OPC, JMS and MQSeries.

30. The system of claim 25, where said software comprises:
a handler/scanner module receiving the RFID tag data;
a logic flow engine module receiving the RFID tag data from the handler/scanner and executing and applying local business rules and logic to the received RFID tag data; and
a transport server receiving the RFID data from the logic flow engine and transmitting the RFID tag data to the enterprise level business application,
wherein the handler/scanner includes a PLC driver for sending the RFID tag data to the memory of the PLC.

31. The system of claim 30, wherein the PLC driver sends RFID tag data to the PLC memory via a PLC backplane communication link.

32. The system of claim 30, wherein the logic flow engine decides: (a) if the RFID tag data is to be passed to an enterprise level business application and which enterprise level business application it should be passed to, and (b) if the RFID tag data is to be passed to the memory of the PLC.

33. The system of claim 32, wherein if the data is to be sent to an enterprise level business application the logic flow engine reformats the RFID tag data in accordance with its target enterprise level business application.

34. The system of claim 30, wherein the handler/scanner decides: (a) if the RFID tag data is to be passed to an enterprise level business application and which enterprise level business application it should be passed to, and (b) if the RFID tag data is to be passed to the memory of the PLC.

35. The system of claim 34, wherein if the data is to be sent to an enterprise level business application the handler/scanner reformats the RFID tag data in accordance with its target enterprise level business application.

36. The system of claim 30, wherein the handler/scanner includes a reader driver receiving RFID tag data from the RFID reader.

37. The system of claim 30, wherein the reader driver polls the RFID reader for RFID tag data.

38. The system of claim 30, wherein said software further comprises a logging server receiving and storing information in a database.

39. The system of claim 30, wherein the RFID reader includes means for providing an indication event of a successful read, wherein the logic flow engine instructs the handler/scanner to activate the indication means upon a successful RFID tag read.

40. The system of claim 39, wherein the indication means is selected from the group consisting of a visual indicator, an audio indicator, a PLC device status change, a screen update and a PLC device variable change.

41. The system of claim 30, wherein the handler/scanner includes a plurality of reader drivers receiving RFID tag data from a plurality of RFID readers.

42. The system of claim 41, wherein each reader driver is connected to one RFID reader and communicates using the protocol of the RFID reader to which it is connected.

43. The system of claim 30, wherein the RFID tag data is encrypted prior to transmission to the RFID reader, and wherein the logic flow engine decrypts the RFID tag data according to a decryption key.

44. The system of claim 43, wherein the RFID tag data includes a set number of bits that identify the tag source, and wherein the logic flow engine determines the appropriate decryption key based on the set number of bits identifying the tag source.

45. The system of claim 44, wherein the logic flow engine selects a decryption key from a key storage table based on the set number of bits identifying the tag source, wherein the key storage table includes a list of vendor ID numbers and corresponding key information for decryption.

46. The system of claim 30, wherein the software includes one or more configuration tools containing a record of all defined projects, transports and general setting, and wherein the software can reset itself to a previous setting using the configuration tools upon recovery from a power failure condition.

47. The system of claim 46, wherein the configuration tools provide information to a user in a tree format, wherein the user can drag and drop data elements or logic elements to create associations and rules between different elements.

48. The system of claim 46, wherein the configuration tools scan for active RFID connections at initialization and present a list of active readers to a user for configuration.

49. The system of claim 46, wherein the configuration tools allow a user to define a set of rules to apply before transmitting the RFID tag data.

50. The system of claim 49, wherein the set of rules includes not to take repeat reads, look for a range of acceptable information before reporting, and define a trigger to turn a reader on.

51. A system for communicating RFID tag data from an RFID reader to an enterprise level business application, said system comprising:
an RFID reader having one or more RF antennas operably coupled thereto for detecting RFID tag data;
an edge controller in communication with the RFID reader and receiving RFID tag data from the RFID reader; and
software installed on the edge controller, wherein the software can: (a) process the RFID tag data, (b) decide if the RFID tag data is to be passed to an enterprise level business application and which enterprise level business application it should be passed to, and (c) transmit the RFID tag data directly to the enterprise level business application based on the decision in (b).

52. The system of claim 51, wherein the enterprise level business application comprises a PLC.

53. The system of claim 52, wherein the RFID data is pushed into the PLC memory via a PLC remote communication link.

54. The system of claim 51, wherein said software can decide to print a label (RFID or barcode) and send a signal to an attached printer with the RFID tag data to be printed.

55. The system of claim 51, wherein said software includes local business rules and/or logic installed thereon, and wherein said software processes the RFID tag data according to the local business rules and/or logic.

56. The system of claim 51, wherein the RFID tag data is sent to the enterprise level business application via a protocol selected from the group consisting of ODBC, JDBC, CLI, Oracle, DB2, OPC, JMS and MQSeries.

57. The system of claim 51, where said software comprises:
a handler/scanner module receiving the RFID tag data;
a logic flow engine module receiving the RFID tag data from the handler/scanner and executing and applying local business rules and logic to the received RFID tag data; and
a transport server receiving the RFID data from the logic flow engine and transmitting the RFID tag data to the enterprise level business application.

58. The system of claim 57, wherein the logic flow engine decides if the RFID tag data is to be passed to an enterprise level business application and which enterprise level business application it should be passed to, and wherein the logic flow engine reformats the RFID tag data in accordance with its target enterprise level business application.

59. The system of claim 57, wherein the handler/scanner decides if the RFID tag data is to be passed to an enterprise level business application and which enterprise level business application it should be passed to, and wherein the handler/scanner reformats the RFID tag data in accordance with its target enterprise level business application.

60. The system of claim 51, wherein the handler/scanner includes a reader driver receiving RFID tag data from the RFID reader.

61. The system of claim 60, wherein the reader driver polls the RFID reader for RFID tag data.

62. The system of claim 51, wherein said software further comprises a logging server receiving and storing information in a database.

63. The system of claim 51, wherein the RFID reader includes means for providing an indication event of a successful read, wherein the logic flow engine instructs the handler/scanner to activate the indication means upon a successful RFID tag read.

64. The system of claim 63, wherein the indication means is selected from the group consisting of a visual indicator, an audio indicator, a PLC device status change, a screen update and a PLC device variable change.

65. The system of claim 51, wherein the handler/scanner includes a plurality of reader drivers receiving RFID tag data from a plurality of RFID readers.

66. The system of claim 65, wherein each reader driver is connected to one or more RFID reader(s) and communicates using the protocol of the RFID reader to which it is connected.

67. The system of claim 51, wherein the RFID tag data is encrypted prior to transmission to the RFID reader, and wherein the logic flow engine decrypts the RFID tag data according to a decryption key.

68. The system of claim 67, wherein the RFID tag data includes a set number of bits that identify the tag source, and wherein the logic flow engine determines the appropriate decryption key based on the set number of bits identifying the tag source.

69. The system of claim 68, wherein the logic flow engine selects a decryption key from a key storage table based on the set number of bits identifying the tag source, wherein the key storage table includes a list of vendor ID numbers and corresponding key information for decryption.

70. The system of claim 51, wherein the software includes one or more configuration tools containing a record of all defined projects, transports and general setting, and wherein the software can reset itself to a previous setting using the configuration tools upon recovery from a power failure condition.

71. The system of claim 70, wherein the configuration tools provide information to a user in a tree format, wherein the user can drag and drop data elements or logic elements to create associations and rules between different elements.

72. The system of claim 70, wherein the configuration tools scan for active RFID connections at initialization and present a list of active readers to a user for configuration.

73. The system of claim 70, wherein the configuration tools allow a user to define a set of rules to apply before transmitting the RFID tag data.

74. The system of claim 73, wherein the set of rules includes not to take repeat reads, look for a range of acceptable information before reporting, and define a trigger to turn a reader on.
